(19) United States
(12) Patent Application Publication
(10) Pub. No.: US 2013/0301928 A1
(43) Pub. Date: Nov. 14, 2013

(54) SHIFT VECTOR RELIABILITY DETERMINING APPARATUS AND METHOD

(71) Applicant: SONY CORPORATION, Tokyo (JP)

(72) Inventors: Paul Springer, Stuttgart (DE); Toru Nishi, Tokyo (JP); Matthias Bruggemann, Bueren (DE)

(73) Assignee: Sony Corporation, Tokyo (JP)

(21) Appl. No.: 13/887,021

(22) Filed: May 3, 2013

(30) Foreign Application Priority Data
May 11, 2012 (EP) 12167657.1

(51) Int. Cl. G06T 5/00

(52) U.S. Cl. CPC G06T 5/00
USPC 382/197

(57) ABSTRACT

An apparatus for determining the reliability of shift vectors between two images comprises an image compensation unit for compensating local shifts between a first image and a second image and to obtain a compensated second image. A similarity estimation unit is provided for determining a similarity information by determining one or more similarity measures between said first image and said compensated second image. A vector consistency check device for comparing shift vectors describing the shift between said first image and said second image from different shift estimation directions to obtain a consistency weight information, and a combination unit for combining said similarity information and said consistency weight information to obtain a reliability information describing the reliability of said shift vectors are provided.

### CROSS-REFERENCE TO RELATED APPLICATION

The present application claims priority of European Patent Application No. 12 167 657.1, filed in the European Patent Office on May 11, 2012, the entire contents of which being incorporated herein by reference.

### BACKGROUND

1. Field of the Disclosure

The present disclosure relates to an apparatus and a corresponding method for determining the reliability of a shift vector between two images. Further, the present disclosure relates to an image enhancement apparatus, a computer program and a computer readable non-transitory medium

2. Description of the Related Art

For many applications in image processing vector fields are used which describe correspondences (also called shifts hereinafter) between different images. Examples for these methods are Motion Compensation, Super-Resolution, Temporal Filtering, Synthetic View Generation for Multi-View Displays, Depth Estimation in 3D Sequences, De-Interlacing or Segmentation. Motion and Disparity Estimation is a difficult task and in many cases it is not possible to achieve correct and reliable vector fields. The mentioned applications often rely on the vectors and the output quality in many cases strongly depends on the vector quality. A good estimation of the reliability of the input vectors can help to avoid artifacts from erroneous vectors.

In M. Tanaka and M. Okutomi, “Toward Robust Reconstruction-Based Super-Resolution,” in Super-Resolution Imaging, P. Milanfar, Ed. Boca Raton: CRC Press, 2011, pp. 219-244 a method for selecting pixel values from a compensated input for a robust Super-Resolution method is presented. The normalized cross correlation is used as a local similarity estimation in combination with a local displacement estimation, computing local sub-pixel shifts and excluding pixels with a low similarity and a high displacement from being processed.

In US 2010/0119176 A1 a temporally recursive Super-Resolution system is presented that computes the local pixel difference between reference input and compensated input to generate a mask for mixing both inputs and using the result as input for the detail generation step.

In Demin Wang, André Vincent, and Philip Blanchfield, “Hybrid De-Interlacing Algorithm Based on Motion Vector Reliability” IEEE Transactions on circuits and systems for video technology, Vol. 15, No. 8, August 2005 discloses a hybrid de-interlacing method that includes switching between a spatial and a motion compensated processing depending on the vector reliability. The vector reliability is computed by comparing the current vector with spatially neighboring vectors depending on a probability function.

The “background” description provided herein is for the purpose of generally presenting the context of the disclosure. Work of the presently named inventor(s), to the extent it is described in this background section, as well as aspects of the description which may not otherwise qualify as prior art at the time of filing, are neither expressly or impliedly admitted as prior art against the present invention.

### SUMMARY

It is an object to provide an apparatus and a corresponding method for determining the reliability of a shift vector between two images with higher accuracy and reliability than known apparatus and methods. It is a further object to provide a corresponding computer program for implementing said method and a computer readable non-transitory medium.

According to an aspect there is provided an apparatus for determining the reliability of a shift vector between two images, said apparatus comprising:

an image compensation unit configured to compensate local shifts between a first image and a second image and to obtain a compensated second image,

a similarity estimation device configured to determine a similarity information by determining one or more similarity measures between said first image and said compensated second image,

a vector consistency check device configured to compare shift vectors describing the shift between said first image and said second image from different shift estimation directions to obtain a consistency weight information, and

a combination unit configured to combine said similarity information and said consistency weight information to obtain a reliability information describing the reliability of said shift vectors.

According to a further aspect there is provided an apparatus for determining the reliability of a shift vector between two images, said apparatus comprising:

an image compensation means for compensating local shifts between a first image and a second image and to obtain a compensated second image,

a similarity estimation means for determining similarity information by determining one or more similarity measures between said first image and said compensated second image,

a vector consistency check means for comparing shift vectors describing the shift between said first image and said second image from different shift estimation directions to obtain a consistency weight information, and

a combination means for combining said similarity information and said consistency weight information to obtain a reliability information describing the reliability of said shift vectors.

According to another aspect an image enhancement apparatus for enhancing an input image of a sequence of input images and obtaining an enhanced output image is provided, said apparatus comprising

a shift apparatus for shifting one or more images by use of shift vectors between two images, and

an apparatus for determining the reliability of said shift vectors as proposed herein, wherein said shift apparatus is configured to take said reliability into account when using said shift vector for shifting one or more images

According to still further aspects a corresponding method, a computer program comprising program means for causing a computer to carry out the steps of the method disclosed herein, when said computer program is carried out on a computer, as well as a non-transitory computer-readable recording medium that stores therein a computer program product, which, when executed by a processor, causes the method disclosed herein to be performed are provided.

Preferred embodiments are defined in the dependent claims. It shall be understood that the claimed method, the claimed computer program and the claimed computer-readable recording medium have similar and/or identical preferred embodiments as the claimed apparatus and as defined in the dependent claims.

The proposed apparatus and method compute the reliability of shift vectors (also called correspondence vectors), in particular of motion and/or disparity vectors. The reliability is computed by combining two means, a vector consistency check and a vector similarity check. The vector consistency check compares vectors from two vector estimations with inverse estimation direction against each other. The vector similarity check calculates several similarity measures for comparing a reference input and the result from an image compensation based on the input vectors. The results of these means are several weighting factors which are combined to a final reliability measure for each input vector.

The computed vector reliability measure for one or more shift vectors can be used in many applications for avoiding artifacts resulting from erroneous vectors. In contrast to the known methods the proposed apparatus and method use one or more (preferably multiple) similarity measures specified for local image characteristics in combination with a consistency check for shift vectors.

It is to be understood that both the foregoing general description of the invention and the following detailed description are exemplary, but are not restrictive, of the invention.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 shows a first embodiment of the proposed reliability determination apparatus,

FIG. 2 shows a second embodiment of the proposed reliability determination apparatus,

FIG. 3 shows a third embodiment of the proposed reliability determination apparatus,

FIG. 4 shows a fourth embodiment of the proposed reliability determination apparatus,

FIG. 5 shows a fifth embodiment of the proposed reliability determination apparatus, and

FIG. 6 shows an embodiment of the proposed image enhancement apparatus.

### DETAILED DESCRIPTION OF THE EMBODIMENTS

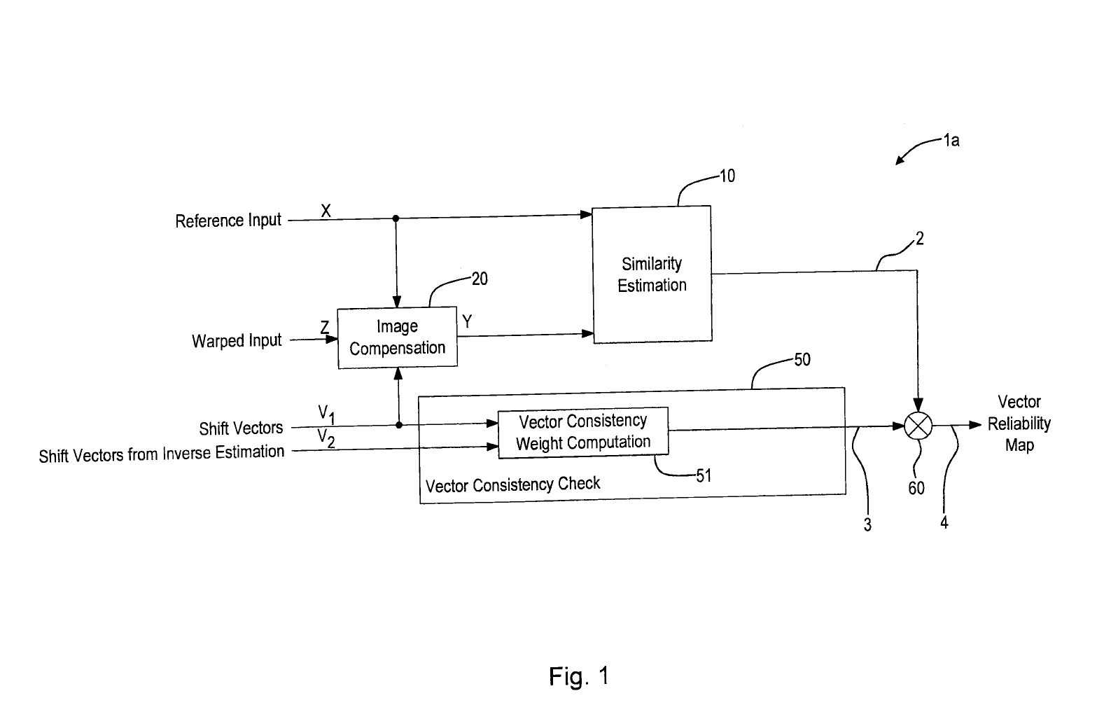

Referring now to the drawings, wherein like reference numerals designate identical or corresponding parts throughout the several views, FIG. 1 schematically depicts a first embodiment of the proposed reliability determination apparatus 1a. It comprises a similarity estimation device 10, an image compensation unit 20, a vector consistency check device 50 and a combination unit 60.

The image compensation unit 20 is configured to compensate local shifts between a first image X (e.g. a reference input which may be the current image of a sequence of images of a video stream) and a second image Z (e.g. a warped input which may be the preceding image of said sequence of images) and to obtain a compensated second image Y. The similarity estimation device 10 is configured to determine a similarity information 2 by determining one or more similarity measures between said first image X and said compensated second image Y.

The vector consistency check device 50 is configured to compare shift vectors V₁, V₂ describing the shift between said first image X and said second image Z from different shift estimation directions to obtain a consistency weight information 3. In this embodiment, a vector consistency weight computation unit 51 is provided for this purpose.

The combination unit 60 is configured to combine said similarity information 2 and said consistency weight information 3 to obtain a reliability information 4 describing the reliability of said shift vectors. Preferably, said combination unit 60 is a multiplication unit for multiplying said similarity information 2 and said consistency weight information 3 to obtain said reliability information 4.

Thus, the proposed apparatus 1 computes a reliability measure (the reliability information 4) for shift vectors (in particular motion and/or disparity vectors, or in general for vectors describing local (pixel) shifts) between two images. The vector reliability is computed by a combination of a vector consistency check, comparing the vectors from two different estimation directions, and a similarity estimation between two images, in particular a reference input and a warped input, which is compensated depending on the input vectors, resulting from a vector estimation method. The vector reliability is thus a combination (in particular a product) of at least two (preferably several) weighting factors computed from one or more (different) similarity measure(s) and the vector consistency.

As already mentioned, the vector consistency is computed by comparing vectors from different estimation directions. If motion vectors shall be checked for consistency for example the estimated motion vectors from the time instance t to t-1 can be compared to inverse estimated motion vectors from t-1 to t. If disparity vectors shall be checked for consistency, the estimated disparity vectors from left view to right view can be compared to the estimated vectors from right view to left view. Obviously for this purpose it is preferred that two inverse estimated vector fields are available as input V₁, V₂. The consistency weight 3 is computed depending on the difference between the inverse vectors V₁, V₂.

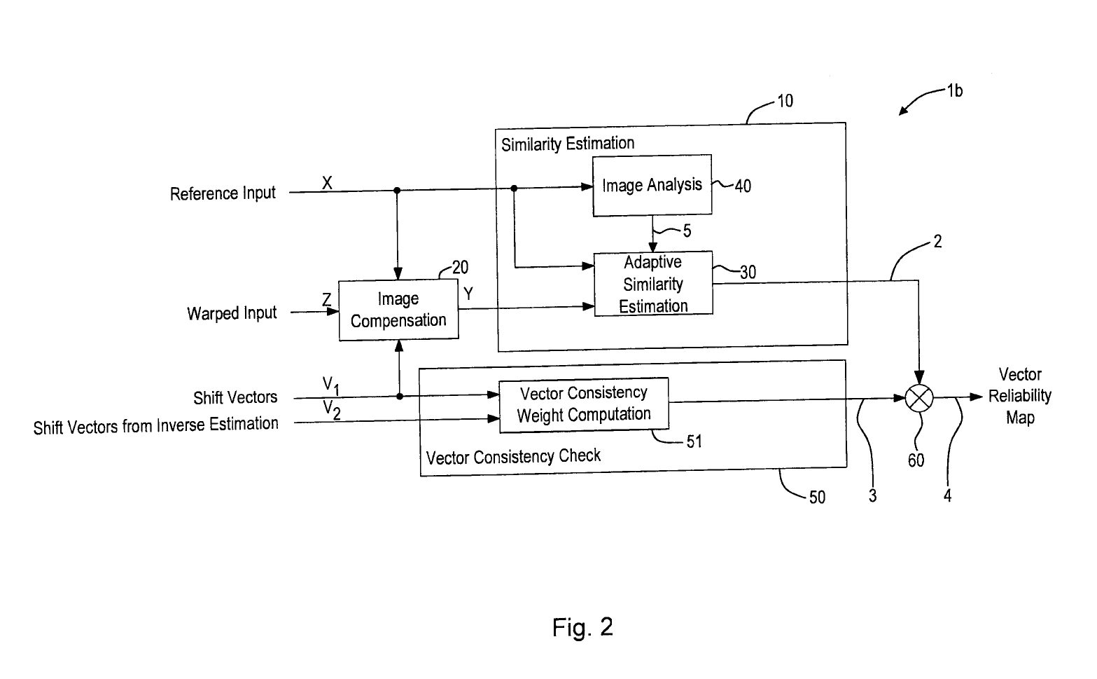

FIG. 2 shows a second embodiment of the proposed reliability determination apparatus 1b. In addition to the embodiment shown in FIG. 1, the similarity estimation device 10 comprises an (optional) image analysis unit 40 configured to analyse the first image X (and/or second image Z in other embodiments) to obtain a feature information 5 indicating one or more image features of the respective image. Further, the similarity estimation device 10 comprises an adaptive similarity estimation unit 30 to adaptively determine one or more similarity measures depending on said feature information 5 to obtain said similarity information 2.

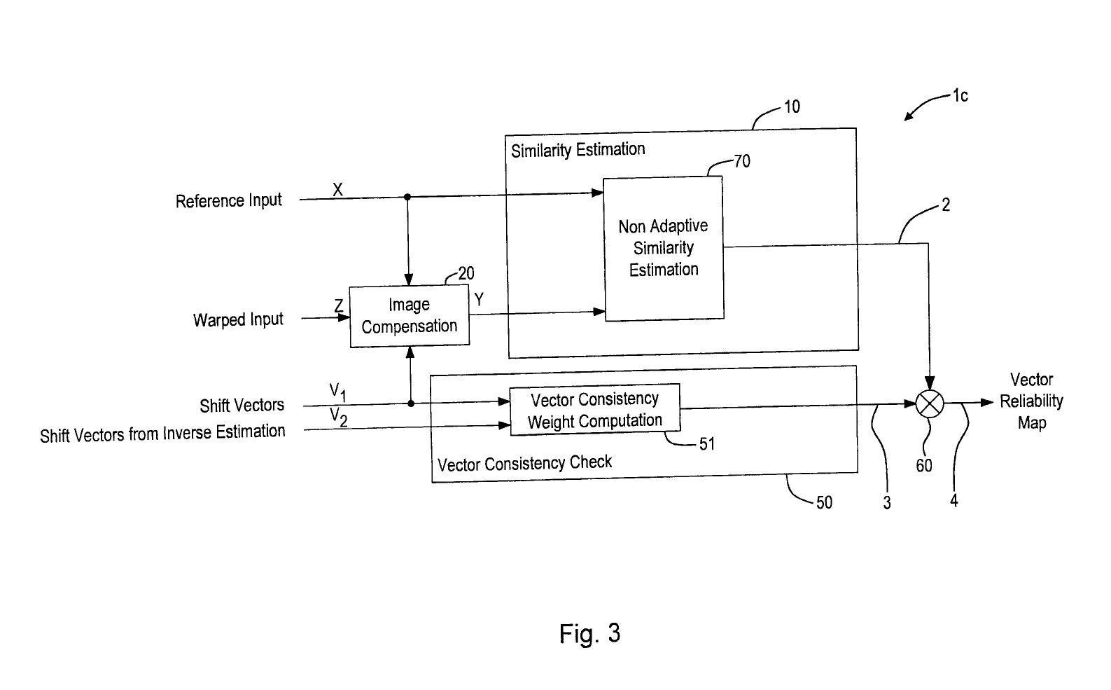

FIG. 3 depicts a third embodiment of the proposed reliability determination apparatus 1c. Compared to the second embodiment the similarity estimation device 10 comprises a non-adaptive similarity estimation unit 70 configured to non-adaptively determine one or more similarity measures independent from said feature information 5 to obtain said similarity information 2.

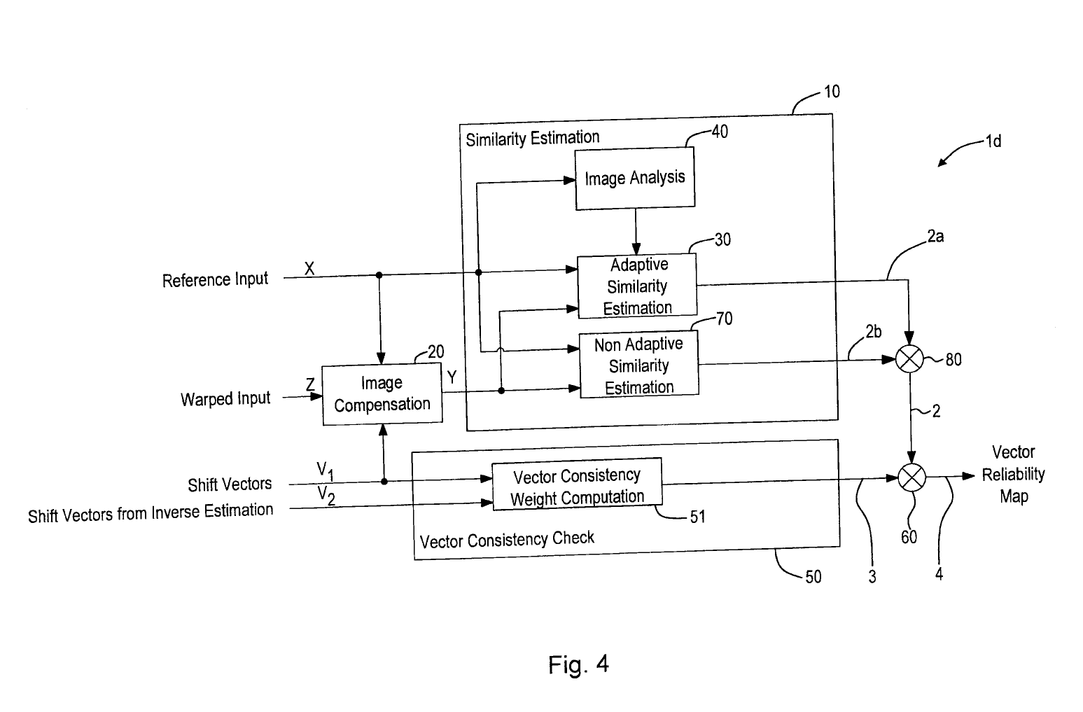

FIG. 4 depicts a fourth embodiment of the proposed reliability determination apparatus 1d which is basically a combination of the second and third embodiments 1b, 1c. In this embodiment the image analysis unit 40, the adaptive similarity estimation unit 30 and the non-adaptive similarity estimation unit 70 are provided. The adaptive similarity estimation unit 30 provides a first similarity information 2a and the non-adaptive similarity estimation unit 70 provides a second similarity information 2b. Further a second multiplication unit 80 is provided to combine the first similarity information 2a obtained by the adaptive similarity estimation unit 30 and the second similarity information 2b obtained by the non-adaptive similarity estimation unit 70. The result 2 of said multiplication unit 80 is multiplied with said consistency weight information 3 to obtain the reliability information 4.

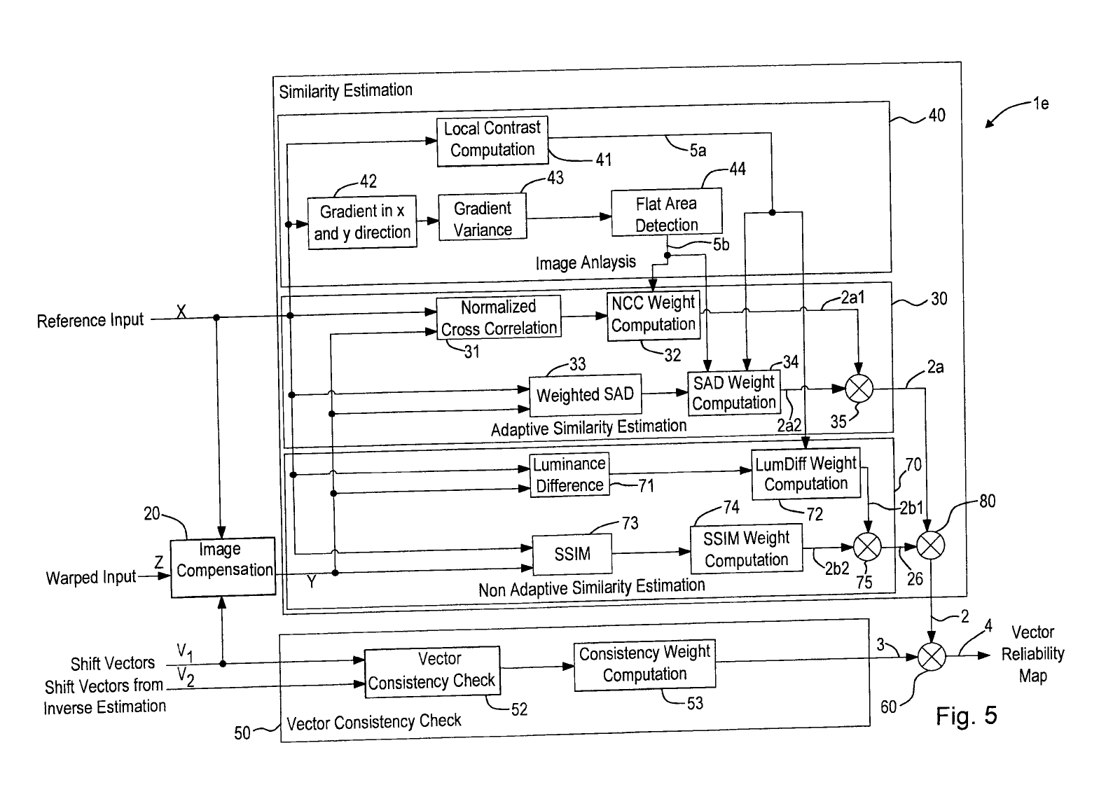

FIG. 5 depicts a fifth embodiment of the proposed reliability determination apparatus 1b. In this embodiment the similarity 2 is computed depending on four different similarity measures. Further, the image analysis unit 40 comprises a contrast determination unit 41 configured to determine a contrast information 5a indicating the local contrast of an input image and a flat area detection device configured to determine a flatness information 5b indicating flat and textured areas of an input image. The flat area detection device comprises a gradient detection unit 42 configured to determine the gradient in two directions, in particular two orthogonal directions, for an input image, a gradient variance computing unit 43 configured to compute the variance of the determined gradients, and a flat area detection unit 44 configured to determine said flatness information 5b by use of a gradient variance threshold.

The adaptive similarity estimation unit 30 is configured to adaptively determine a normalized cross correlation weight factor 2a1 from said first image X and said compensated second image Y using said flatness information 5b. The normalized cross correlation obtained by a normalized cross correlation unit 31 is a reliable similarity measure in texture areas, therefore the normalized cross correlation NCC weight is computed in a NCC weight computation unit 32 depending on the image area the observed pixel is located in. In flat areas it is preferably set to 1, so that it does not affect the final reliability value.

Further, in this embodiment said adaptive similarity estimation unit 30 is configured to adaptively determine a summed absolute difference weight factor 2a2 from said first image X and said compensated second image Y using said flatness information 5b and said contrast information 5a. Particularly in flat areas the weighted SAD obtained by a weighted SAD unit 33 is used for similarity estimation. In a SAD weight computation unit 34 the SAD weight is determined, whereby the SAD weight is set to 1 in texture areas. To be able to distinguish whether the current pixel is located in a flat or textured region, the flatness information 5b is used.

The normalized cross correlation weight factor 2a1 and the summed absolute difference weight factor 2a2 are finally multiplied by a multiplication unit 35 to obtain the first similarity information 2a.

The non-adaptive similarity estimation unit 70 is configured to determine a structural similarity (SSIM) weight factor 2b2 from said first image X and said compensated second image Y. Thus, as a further similarity measure the SSIM, which is a combination of luminance, contrast and structure comparison, is determined in a SSIM determination unit 73. Based on this measure the SSIM weight factor 2b2 is computed as a further weighting factor in an SSIM weight computation unit 74. These three measures are preferably all computed in local block areas, therefore they describe an average over a set of pixels.

Strong single pixel differences might not be regarded. Therefore the non-adaptive similarity estimation unit 70 is further configured to determine a luminance difference weight factor 2b1 from said first image X and said compensated second image Y using said contrast information 5a. Thus, the single pixel luminance difference is computed in a luminance difference determination unit 71 and the luminance difference weight factor 2b1 is computed as a further weighting factor based on this value in a luminance difference weight computation unit 72. The SAD weight and the luminance difference weight are computed depending on the local contrast, as SAD and luminance difference strongly depend on this value.

The luminance difference weight factor 2b1 and the SSIM weight factor 2b2 are finally multiplied by a multiplication unit 75 to obtain the second similarity information 2b.

The vector consistency check device 50 is configured to compare the difference between said shift vectors V₁, V₂ to a shift threshold in a vector consistency check unit 52 and to set said consistency weight information 3 to a first or a second value depending on the result of said comparison in a consistency weight computation unit 53.

The final vector reliability 4 is computed as a product of the five described weighting factors. Preferably, as output a vector reliability map is computed by multiplying a map which is initially set to 1 with the locally computed factors.

Exemplary embodiments of the computation of the different weighting factors and the image analysis methods are described in the following.

The image compensation unit 20 compensates the local shifts between two images X, Z, for example between the temporal instances t and t-1 or between left and right view. These shifts are described by shift vectors V₁=(vₓ, v_{y}) for each pixel. The motion compensation is realized using the following equation:

Y(x,y)=Z(x+vₓ,y+v_{y}) (1)

The shift vectors can be sub-pixel accurate, in this case for image compensation these sub-pixel positions have to be interpolated. A possible solution is the utilization of a bilinear interpolation. The luminance values of the compensated image are computed as follows:

$$Y ( x , y ) = Z ( ⌊ x + {v}_{x} ⌋ , ⌊ y + {v}_{y} ⌋ ) \cdot ( ⌊ x + {v}_{x} ⌋ + 1 - ( y + {v}_{x} ) ) \cdot ( ⌊ y + {v}_{y} ⌋ + 1 - ( y + {v}_{y} ) ) + Z ( ⌊ x + {v}_{x} ⌋ , ⌊ y + {v}_{y} ⌋ + 1 ) \cdot ( ⌊ x + {v}_{x} ⌋ + 1 - ( x + {v}_{x} ) ) \cdot ( ( y + {v}_{y} ) - ⌊ y + {v}_{y} ⌋ ) + Z ( ⌊ x + {v}_{x} ⌋ + 1 , ⌊ y + {v}_{y} ⌋ ) \cdot ( ( x + {v}_{x} ) - ⌊ x + {v}_{x} ⌋ ) \cdot ( ⌊ y + {v}_{y} ⌋ + 1 - ( y + {v}_{y} ) ) + Z ( ⌊ x + {v}_{y} ⌋ + 1 , ⌊ y + {v}_{y} ⌋ + 1 ) \cdot ( ( x + {v}_{x} ) - ⌊ x + {v}_{x} ⌋ ) \cdot ( ( y + {v}_{y} ) - ⌊ y + {v}_{y} ⌋ ) \qquad ( 2 )$$

If the accessed image position of the previous result is out of range, the luminance value of the reference input X is copied.

The local contrast 5a is computed inside a local block area, e.g. a 3×3 block area, around the currently processed pixel value. Inside this area the minimum and maximum value are detected. The local contrast 5a is defined as difference between minimum and maximum value inside the local block area.

As already mentioned, the flat area detection is based on the local gradient variance. In a first step the absolute gradient is computed for the whole image. The gradients in x- and y-directions are computed by simple difference operators.

gradX(x,y)=X(x,y)−X(x−1,y)

gradY(x,y)=X(x,y)−X(x,y−1) (3)

Then the absolute gradient is computed by the following operation:

grad=\sqrt{gradX²+gradY²} (4)

The gradient variance is computed inside a local block area C, e.g. a 5×5 block area:

$$\begin{matrix}gradVar ( x , y ) = \sqrt{{\sum }_{( u , v ) ∈ C ( x , y )} {[ grad ( u , v ) - {μ}_{grad} ]}^{2}} \\ with & ( 5 ) \\ {μ}_{grad} = \frac{1}{25} {\sum }_{( u , v ) ∈ C ( x , y )} grad ( u , v ) & ( 6 )\end{matrix}$$

Finally the flat area 5a is detected using a binary decision based a gradient variance threshold.

flat area: gradVar≦Threshold

texture area: gradVar≧Threshold

The normalized cross correlation (NCC) is computed for each pixel inside a local block area C, e.g. in a 5×5 block area, around the currently processed image position (x, y) using the following equation

$$NCC ( x , y ) = \frac{{\sum }_{( u , v ) ∈ C ( x , y )} [ X ( u , v ) \times Y ( u , v ) ]}{\sqrt{{\sum }_{( u , v ) ∈ C ( x , y )} {X ( u , v )}^{2} \times {\sum }_{( u , v ) ∈ C ( x , y )} {Y ( u , v )}^{2}}} \qquad ( 7 )$$

The NCC weighting factor 2a1 is computed for each pixel based on two thresholds Thr1≧Thr2 using the following equation:

$$NCC Weight ( x , y ) = \{ \begin{matrix}1 , & NCC ( x , y ) \geq Thr 1 \\ \frac{NCC ( x , y ) - Thr 2}{Th 1 - Thr 2} , & Thr 2 < NCC ( x , y ) < Th 1 \\ 0 , & NCC ( x , y ) \leq Thr 2\end{matrix} \qquad ( 8 )$$

In case Thr1 equals Thr2 a binary weighting factor is realized, for offering a hard reliability decision. In flat areas the NCC weight 2a1 is also set to 1, as in flat areas the normalized cross correlation is an unreliable similarity measure.

he weighted SAD is computed for each pixel inside a local block area C, e.g. a 3×3 block area, around the currently processed image position (x, y) using the following equation

$$SAD ( x , y ) = \frac{{\sum }_{( u , v ) ∈ C ( x , y )} {w}_{u , v} \cdot abs [ X ( u , v ) - Y ( u , v ) ]}{{\sum }_{( u , v ) ∈ C ( x , y )} {w}_{u , v}} \qquad ( 9 )$$

Exemplary (already normalized) weights are

$${w}_{u , v} = \begin{matrix}0.05 & 0.1 & 0.05 \\ 0.1 & 0.4 & 0.1 \\ 0.05 & 0.1 & 0.05\end{matrix} \qquad ( 10 )$$

The SAD weighting factor 2a2 is computed for each pixel based on two thresholds Thr1≧Thr2 using the following equation:

$$SAD Weight ( x , y ) = \{ \begin{matrix}0 , & SAD ( x , y ) \geq Thr 1 \\ \frac{Thr 1 - SAD ( x , y )}{Thr 1 - Thr 2} , & Thr 2 < SAD ( x , y ) < Thr 1 \\ 1 , & SAD ( x , y ) \leq Thr 2\end{matrix} \qquad ( 11 )$$

In case Thr1 equals Thr2 a binary weighting factor is realized, for offering a hard reliability decision. In texture areas the SAD weight 2a2 is set to 1, as in texture areas the normalized cross correlation is an unreliable similarity measure. Thr1 and Thr2 are selected depending on the local contrast for example Thr1=1.2·localContrast and Thr2=0.7·localContrast.

The SSIM is computed for each pixel inside a local block area C, e.g. a 5×5 block area, around the currently processed image position (x, y) using the following equation

$$\begin{matrix}SSIM ( x , y ) = 1 ( x , y ) \cdot c ( x , y ) \cdot s ( x , y ) \\ with & ( 12 ) \\ 1 ( x , y ) = \frac{2 {μ}_{X} {μ}_{Y} + {C}_{1}}{{μ}_{X}^{2} + {μ}_{Y}^{2} + {C}_{1}} , & ( 13 ) \\ c ( x , y ) = \frac{2 {σ}_{X} {σ}_{Y} + {C}_{2}}{{σ}_{X}^{2} + {σ}_{Y}^{2} + {C}_{2}} & ( 14 ) \\ s ( x , y ) = \frac{{σ}_{XY} + {C}_{3}}{{σ}_{X} {σ}_{Y} + {C}_{3 }} \\ and & ( 15 ) \\ {μ}_{X} = \frac{1}{25} {\sum }_{( u , v ) ∈ C ( x , y )} X ( u , v ) , & ( 16 ) \\ {μ}_{Y} = \frac{1}{25} {\sum }_{( u , v ) ∈ C ( x , y )} Y ( u , v ) , & ( 17 ) \\ {σ}_{X} = {( \frac{1}{24} {\sum }_{( u , v ) ∈ C ( x , y )} {( Y ( u , v ) - {μ}_{X} )}^{2} )}^{\frac{1}{2}} , & ( 18 ) \\ {σ}_{Y} = {( \frac{1}{24} {\sum }_{( u , v ) ∈ C ( x , y )} {( Y ( u , v ) - {μ}_{Y} )}^{2} )}^{\frac{1}{2}} , & ( 19 ) \\ {σ}_{XY} = ( \frac{1}{24} {\sum }_{( u , v ) ∈ C ( x , y )} ( X ( u , v ) - {μ}_{X} ) \cdot ( Y ( u , v ) - {μ}_{Y} ) ) & ( 20 )\end{matrix}$$

The SSIM weighting factor 2b2 is computed for each pixel based on two thresholds Thr1≧Thr2 using the following equation:

$$SSIM Weight ( x , y ) = \{ \begin{matrix}1 , & SSIM ( x , y ) \geq Thr 1 \\ \frac{SSIM ( x , y ) - Thr 2}{Thr 1 - Thr 2} , & Thr 2 < SSIM ( x , y ) < Thr 1 \\ 0 , & SSIM ( x , y ) \leq Thr 2\end{matrix} \qquad ( 0 )$$

In case Thr1 equals Thr2 a binary weighting factor is realized for offering a hard reliability decision.

The similarity measures 2a1, 2a2, 2b2 mentioned up to now are all preferably computed inside a local block area, describing an average over a set of pixels. Strong differences between X and Y that are spatially limited to one pixel (similar to salt and pepper noise) might not be sufficiently regarded. Therefore a further weighting factor 2b1 is computed depending on the pixel-wise luminance difference which is defined by

lumDiff(x,y)=|X(x,y)−Y(x,y)| (21)

The luminance difference dependent weighting factor is computed for each pixel based on two thresholds Thr1≧Thr2 using the following equation:

$$lumDiff Weight ( x , y ) = \{ \begin{matrix}0 , & lumDiff ( x , y ) \geq Thr 1 \\ \frac{Thr 1 - lumDiff ( x , y )}{Thr 1 - Thr 2} , & Thr 2 < lumDiff ( x , y ) < Thr 1 \\ 1 , & lumDiff ( x , y ) \leq Thr 2\end{matrix}$$

In case Thr1 equals Thr2 a binary weighting factor is realized, for offering a hard reliability decision. Thr1 and Thr2 are selected depending on the local contrast and should be higher than the SAD thresholds, for example Thr1=1.6·localContrast and Thr2=1.2·localContrast.

For the vector consistency check shift vectors, e.g. motion vectors, from two inverse estimation directions are compared. If the difference between the two compared vectors is above a defined threshold, the vector is assumed to be unreliable. For vector comparison the vector

$$v 1 ( x , y ) = ( \begin{matrix}v {1}_{x} ( x , y ) \\ v {1}_{y} ( x , y )\end{matrix} ) \qquad ( 23 )$$

is compared to the projected inverse vector

$$v 2 ( x + v {1}_{x} , y + v {1}_{y} ) = ( \begin{matrix}v {2}_{x} ( x + v {1}_{x} , y + v {1}_{y} ) \\ v {2}_{y} ( x + v {1}_{x} , y + v {1}_{y} )\end{matrix} ) \qquad ( 24 )$$

by computing the absolute differences in x and y direction. If one of the differences exceeds a defined threshold the vector consistency weighting factor is set to 0, otherwise it is set to 1.

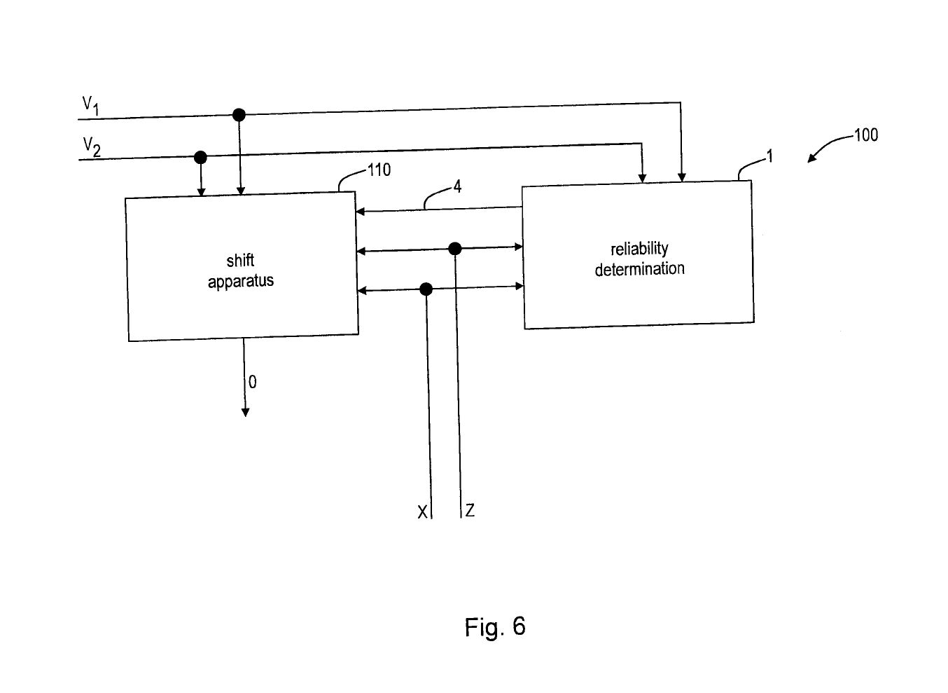

The proposed reliability determination apparatus and method can be used in various constellations and application. An example of an application is illustrated in FIG. 6 showing an embodiment of an image enhancement apparatus 100 for enhancing an input image X of a sequence of input images and obtaining an enhanced output image O. Said apparatus 100 comprises a shift apparatus 110 for shifting one or more images by use of shift vectors between two images, and a proposed reliability determination apparatus 1 (i.e. one of the embodiments 1a, 1b, 1c, 1d, 1e or any other embodiment) for determining the reliability of said shift vectors. Said shift apparatus is configured to take said reliability into account when using said shift vector for shifting one or more images.

Other examples for application of the proposed method and apparatus are Motion Compensation, Super-Resolution, Temporal Filtering, Synthetic View Generation for Multi-View Displays, Depth Estimation in 3D Sequences, De-Interlacing or Segmentation.

The various elements of the different embodiments of the provided apparatus may be implemented as software and/or hardware, e.g. as separate or combined circuits. A circuit is a structural assemblage of electronic components including conventional circuit elements, integrated circuits including application specific integrated circuits, standard integrated circuits, application specific standard products, and field programmable gate arrays. Further a circuit includes central processing units, graphics processing units, and microprocessors which are programmed or configured according to software code. A circuit does not include pure software, although a circuit does include the above-described hardware executing software.

Obviously, numerous modifications and variations of the present disclosure are possible in light of the above teachings. It is therefore to be understood that within the scope of the appended claims, the invention may be practiced otherwise than as specifically described herein.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

In so far as embodiments of the invention have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present invention. Further, such a software may also be distributed in other forms, such as via the Internet or other wired or wireless telecommunication systems.

Any reference signs in the claims should not be construed as limiting the scope.

1. An apparatus for determining the reliability of shift vectors between two images comprising:
an image compensation unit configured to compensate local shifts between a first image and a second image and to obtain a compensated second image,
a similarity estimation device configured to determine a similarity information by determining one or more similarity measures between said first image and said compensated second image,
a vector consistency check device configured to compare shift vectors describing the shift between said first image and said second image from different shift estimation directions to obtain a consistency weight information, and
a combination unit configured to combine said similarity information (2) and said consistency weight information to obtain a reliability information describing the reliability of said shift vectors.

2. The apparatus as claimed in claim 1,
wherein said similarity estimation device comprises
an image analysis unit configured to analyse the first image and/or second image to obtain a feature information indicating one or more image features of the respective image and
an adaptive similarity estimation unit to adaptively determine one or more similarity measures depending on said feature information to obtain a first similarity information.

3. The apparatus as claimed in claim 2,
wherein said adaptive similarity estimation unit is configured to select the kind of similarity measure and/or to set parameters of an applied similarity measure depending on said feature information.

4. The apparatus as claimed in claim 1,
wherein said combination unit is a multiplication unit configured to pixel-wise or pixel-area-wise multiply said similarity information and said consistency weight information to obtain said reliability information.

5. The apparatus as claimed in claim 1,
wherein said vector consistency check device is configured to compare motion vectors describing the motion between said first image and said second image, a first motion vector describing the motion estimated from said first image to said second image and a second motion vector describing the motion estimated from said second image to said first image.

6. The apparatus as claimed claim 1,
wherein said vector consistency check device is configured to compare disparity vectors describing the disparity between said first image of a first view and said second image of a second view, a first disparity vector describing the disparity estimated from said first image to said second image and a second motion vector (V₂) describing the disparity estimated from said second image to said first image.

7. The apparatus as claimed in claim 1,
wherein said similarity estimation device comprises a non-adaptive similarity estimation unit (70)—configured to non-adaptively determine one or more similarity measures independent from feature information to obtain a second similarity information.

8. The apparatus as claimed in claim 2,
wherein said image analysis unit comprises a contrast determination unit configured to determine a contrast information indicating the local contrast of an input image.

9. The apparatus as claimed in claim 2,
wherein said image analysis unit comprises a flat area detection device configured to determine a flatness information indicating flat and textured areas of an input image.

10. The apparatus as claimed in claim 9,
wherein said flat area detection device comprises
a gradient detection unit configured to determine the gradient in two directions, in particular two orthogonal directions, for an input image,
a gradient variance computing unit configured to compute the variance of the determined gradients, and
a flat area detection unit configured to determine said flatness information by use of a gradient variance threshold.

11. The apparatus as claimed in claim 9,
wherein said adaptive similarity estimation unit is configured to adaptively determine a normalized cross correlation weight factor from said first image and said compensated second image using said flatness information.

12. The apparatus as claimed in claim 8,
wherein said adaptive similarity estimation unit is configured to adaptively determine a summed absolute difference weight factor from said first image and said compensated second image using said flatness information and said contrast information (5a).

13. The apparatus as claimed in claim 8,
wherein said non-adaptive similarity estimation unit (70) is configured to determine a luminance difference weight factor (2b1) from said first image (X) and said compensated second image (Y) using said contrast information (5a).

14. The apparatus as claimed in claim 7,
wherein said non-adaptive similarity estimation unit is configured to determine a structural similarity weight factor from said first image and said compensated second image.

15. The apparatus as claimed in claim 1,
wherein said vector consistency check device is configured to compare the difference between said shift vectors to a shift threshold and to set said consistency weight information to a first or a second value depending on the result of said comparison.

16. The apparatus as claimed in claims 7,
wherein said combination unit is configured to combine said first similarity information, second similarity information and said consistency weight information to obtain said reliability information.

17. An apparatus for determining the reliability of shift vectors between two images comprising:
an image compensation means for compensating local shifts between a first image and a second image and to obtain a compensated second image,
a similarity estimation means for determining a similarity information by determining one or more similarity measures between said first image and said compensated second image,
a vector consistency check means for comparing shift vectors describing the shift between said first image and said second image from different shift estimation directions to obtain a consistency weight information, and
a combination means for combining said similarity information and said consistency weight information to obtain a reliability information describing the reliability of said shift vectors.

18. An image enhancement apparatus for enhancing an input image of a sequence of input images and obtaining an enhanced output image, said apparatus comprising
a shift apparatus for shifting one or more images by use of shift vectors between two images, and
an apparatus as claimed in claim 17 for determining the reliability of said shift vectors,
wherein said shift apparatus is configured to take said reliability into account when using said shift vector for shifting one or more images.

19. A method for determining the reliability of shift vectors between two images comprising:
compensating local shifts between a first image and a second image and to obtain a compensated second image, and
determining a similarity information by determining one or more similarity measures between said first image and said compensated second image,
comparing shift vectors describing the shift between said first image and said second image from different shift estimation directions to obtain a consistency weight information, and
combining said similarity information and said consistency weight information to obtain a reliability information describing the reliability of said shift vectors.

20. (canceled)

21. A non-transitory computer-readable recording medium that stores therein a computer program product, which, when executed by a processor, causes the method according to claim 19 to be performed.
